(19) United States
(12) Patent Application Publication
(10) Pub. No.: US 2016/0338400 A1
(43) Pub. Date: Nov. 24, 2016

(54) NATURAL STONE OVEN FOR ROASTING NUTS AND METHODS ASSOCIATED THEREWITH

(71) Applicant: YNuts, LLC, New York, NY (US)

(72) Inventors: David AVITAL, New York, NY (US); Pernilla AVITAL, New York, NY (US)

(73) Assignee: YNuts, LLC, New York, NY (US)

(21) Appl. No.: 15/091,645

(22) Filed: Apr. 6, 2016

Related U.S. Application Data
(60) Provisional application No. 62/163,004, filed on May 18, 2015.
(60) Provisional application No. 62/164,254, filed on May 20, 2015.
(60) Provisional application No. 62/163,572, filed on May 19, 2015.
(60) Provisional application No. 62/163,060, filed on May 18, 2015.

(51) Int. Cl. A23N 12/08; F24C 15/34; F24C 15/16

(52) U.S. Cl. CPC A23N 12/08; F24C 15/16; F24C 15/34; A23L 1/364; A23V 2002/00

(57) ABSTRACT

It has been discovered that a natural stone oven possesses certain advantages in its use in producing a natural nut foodstuff having improved taste and health benefits. Natural stone has a unique ability to heat and flavor food, particularly nuts, when used as an oven at the appropriate temperature since stone has a natural flavoring effect. The use of the stone oven additionally facilitates the production of nut foodstuff without the necessity of using oils, fats, non-natural flavor or color additives or other non-natural additives which are associated with roasting nuts by other mass producers of the same.

The present application claims priority to, and incorporates by reference in its entirety each of the following applications: U.S. Provisional Application No. 62/163,004, filed May 18, 2015; U.S. Provisional Application No. 62/164,254, filed May 20, 2015; U.S. Provisional Application No. 62/163,572, filed May 19, 2015, and U.S. Provisional Application No. 62/163,060, filed May 18, 2015.

### BACKGROUND OF THE INVENTION

Mass produced foods have been both a boon and bane for society. Modern processes have enabled production of large quantities of food to be available at moderate costs for a large number of people. Additives to the food, such as flavoring, coloring, and preservative ingredients, both chemical and biologic have also increased shelf-life, appearance, texture, and palatability of the food.

Like other great contributions to society however, mass produced foods have also increased certain health risks with their consumption. Large quantities of food are processed at unethically high speeds for efficiency resulting in low safety standards, poor food quality, low cleanliness standards, toxins from cleaning chemicals and the machinery, and subsequently food poisoning outbreaks arise from the methods of food preparation in factories. Other consequences of mass produced food are the epidemic of obesity, death of children due to food borne illness and allergy contaminates, and the poor effect on the environment.

Nuts, both tree nuts and legumes, are a popular mass produced snack and small meal item. Nuts may be prepared for consumption a number of different ways, including roasting, dry-roasting, salting (with or without roasting), or boiling, to name a few.

In order to improve the flavor of nuts, they have long been roasted. Roasting is generally accomplished using either heated air or hot oil. Roasting is generally carried out at elevated temperatures by introducing nuts into a roasting oven, maintaining the heat or introducing heat to bring the nut up to a roasting temperature, e.g., 100° C.-200° C., and maintaining the heat at that temperature until the nuts reach proper taste and texture. Additionally, flavor of the roasted nuts can be further improved with the use of coatings and/or flavor oils.

For example, U.S. Pat. No. 4,161,545 discloses a method for applying a honey based coating to nuts. Similarly, U.S. Pat. No. 3,671,766 discloses a process for coating nuts with hexatol containing compositions. U.S. Pat. No. 4,053,650 discloses a method for coating nuts with cereal and wheat flour compositions which are baked onto the roasted nut. U.S. Pat. No. 4,085,230 discloses a process for processing nuts which includes an initial step of cooking the nuts in boiling water for a period of time before roasting. In a final coating step salt and flavoring are applied to the cooled nuts.

Nuts may also be blanched in addition to roasting and/or salting. Blanching is a process wherein the nut is plunged into boiling water, removed after a brief, timed interval, and finally plunged into iced water or placed under cold running water in order to halt the cooking process. U.S. Pat. No. 3,457,087, for example, discloses a method for eliminating “spotting” on nuts which is associated with blanching and roasting processes. The process involves the quenching of hot roasted nuts in copious amounts of cold oil which is said to be absorbed into the nut. Flavorings can be included in the quench oil.

During the initial part of a nut roasting process water is removed from the nut which generally has an initial moisture content of about 4% to 8% by weight. Until the water content is reduced to about 1.5% to 2.5% no browning or flavor development occurs. In addition to loss of water and other volatiles such as aromatics and air the cell structure expands and nut oil moves out of the nut kernel to its surface.

As a result of the loss of volatiles thermal expansion of the nut occurs, forming many small cracks and fissures in the nut. According to U.S. Pat. No. 3,457,087, at this point the nut should be capable of absorbing flavorings readily. However, flavoring added to the hot nuts are generally volatilized and only a minor amount, if any, remains to be absorbed by the nut. Once the nut has cooled the surface oil is absorbed, the nut contracts and the moisture content is equilibrated with the ambient conditions that is about 2% by weight moisture.

As a result of these physical phenomena of the nut during roasting and cooling, the prior art processes fail to impart substantial flavor to the nut itself. In the process of U.S. Pat. No. 3,457,087, for example, the cold oil is applied to hot nuts and as a consequence the flavoring is volatilized in the region immediately adjacent to the nut. There has been a failure in the prior art to recognize that nut surface temperature during the application of flavorings to nuts is critical if the flavoring is to be absorbed rather than remain merely as a surface coating.

While traditional roasting and/or salting or coating methods add flavor to nuts, there are considerable drawbacks associated therewith. Typically roasting takes place in conventional ovens and/or frying apparatuses. Metal machinery, for example, can introduce toxins to the nuts, and often leave the nuts with a metallic taste. Nuts and processed foods can develop metallic tastes due to growing conditions and environmental contamination, machine processing, improper cooking, preparation and food storage techniques. Similarly, foods grown in soils or irrigated with water that has high metal content could impart metallic flavors to food products. Most importantly, if the metallic taste is due to metal machinery, specifically heavy metals such as lead, mercury, or other dangerous contaminants, there is a dangerous health risk. There, therefore, exists a strong need for more organic ovens, and methods associated therewith for roasting nuts in a healthier manner, leaving a nut product with an improved taste.

### SUMMARY

The present invention therefore provides a method of roasting nuts. The method includes: i) providing a natural stone oven; ii) heating the natural stone oven to a temperature appropriate to roast nuts; iii) placing the nuts in the natural stone oven to be roasted; and iv) heating the nuts for an amount of time sufficient to roast the nuts.

In an embodiment, the natural stone oven is selected from the group comprising lava rock, soapstone, and slate ovens. In an embodiment, the natural stone oven is comprised of soapstone. In another embodiment, the natural stone oven is comprised of slate. In another embodiment, the natural stone oven is comprised of lava rock.

In an embodiment, the method of the present invention further comprises roasting the nuts in a natural stone oven, wherein the nuts are at least partially coated with a natural flavorant or adhesive. The method further includes at least partially coating the nuts with a natural flavorant or adhesive.

In an embodiment, the natural stone oven of the present invention is heated by a heat source selected from the group of gas, coal, charcoal, electric, infrared, or wood-burning. In a preferred embodiment, the natural stone oven is a charcoal heated oven. In another embodiment the natural stone oven has a substantially planar cooking surface. In yet another embodiment, the nuts are heated directly on the planar surface.

In an embodiment, the nuts are roasted in the natural stone oven at a temperature appropriate to roast the nuts; which is between about 200° F. and about 450° F. In an embodiment, the time for roasting the nuts is between about 1 minute and about 30 minutes. In an embodiment, the nuts are almonds. In an embodiment, the nuts are coated with a natural adhesive selected from the group of xanthan, arabic, guar, dextrins, modified starches, a dried adhesive, or yerba mate. In another embodiment, a natural flavorant is added to the nuts after the natural adhesive has been added, the natural flavorant selected from the group of salts, sea salts, and unprocessed salt.

In an embodiment, the present invention also provides a natural stone oven designed for roasting nuts, the oven includes a natural stone heating surface designed for retaining and transmitting heat from a source to nuts placed in a roasting position. The heating surface may be comprised of soapstone, slate, or lava rock. In an embodiment, the soapstone or slate surface comprises a planar surface in a closed heating environment.

For a better understanding of the present invention, together with other and further objects and advantages, reference is made to the following detailed description, taken in conjunction with the accompanying examples, and the scope of the invention will be pointed out in the appended claims. The following detailed description is not intended to restrict the scope of the invention by the advantages set forth above.

### DETAILED DESCRIPTION

The inventors of the present invention have discovered unexpectedly that a natural stone oven possesses certain advantages in its use in producing a natural nut foodstuff having improved taste and health benefits. Natural stone has a unique ability to heat and flavor food, particularly nuts, when used as an oven at the appropriate temperature since stone has a natural flavoring effect. The use of the stone oven additionally facilitates the production of nut foodstuff without the necessity of using oils, fats, non-natural flavor or color additives, or other non-natural additives which are associated with roasting nuts by other mass producers of the same. The combination of a natural stone oven, used to roast the nuts in combination with a natural flavorant and/or a natural adhesive provides an improved nut snack with improved health and taste qualities compared to the prior art.

Although the use of natural stone ovens is known, and has been traditionally used in history, it has been unexpectedly discovered that the presently constructed oven possesses unique advantages over the previously known ovens because it is ideally suited for roasting large quantities of nuts. The use of soapstone, in particular, is advantageous because it retains heat and evenly distributes heat with little wood usage and very little attention. Also the high talc content makes soapstone malleable and therefore it easily can be carved into the desirable roasting surface and oven while maintaining its natural properties including heat conductivity. Soapstone, even though it is soft, is non-porous and therefore has a high density making it naturally impenetrable, even to liquids, and stain-proof. Therefore a soapstone oven is durable and will maintain the integrity and purity of the design.

The use of slate rocks in the natural stone oven may also be advantageous, in particular, because of its durability, indestructability, and functionality as a great heat conductor. A slate oven of the present invention primarily consists of a planar slate surface in a closed oven environment. The planar slate surface may be a cooking surface on which the nuts are placed in a batch cooking process, and may include a number of slate rocks included in a planar surface. The oven may be similarly constructed as a brick oven, with a heat source in the oven itself, or below the surface of the cooking surface. The oven may be domed shaped, or have an arced roof, or it may be rectangular in shape. The oven can have one or two openings, for inserting and removing items. The opening(s) optionally have a door which can be closed to create a closed heating environment. The walls of the oven may be made of slate, or slate rocks in addition to the cooking surface.

In another embodiment, a method of preparing a natural nut-roasting appliance for roasting nuts is provided. The method includes: i) mining naturally occurring slate rock, ii) shaping mined slate rock from step i) to provide slate rock pieces having at least one flat surface suitable for placing nuts for roasting and sized to be heated and to transfer heat to said nuts sufficiently for roasting, and iii) supporting the shaped slate rocks resulting from step ii) in a closed roasting environment suitable to provide naturally-roasted nuts.

As used herein, the term, “slate”, or “slate rock” refers to a fine-grained, foliated, homogeneous metamorphic rock derived from an original shale-type sedimentary rock composed of clay or volcanic ash through low-grade regional metamorphism. It is the finest grained foliated metamorphic rock. Foliation may not correspond to the original sedimentary layering, but instead is in planes perpendicular to the direction of metamorphic compression. The word “slate” is also used for certain types of object made from slate rock. It may mean a single roofing tile made of slate, or a writing slate.

A truly efficient baking oven system should possess two thermal characteristics, thermal conductivity and specific heat, or heat storing capacity. Thermal conductivity refers to the speed and efficiency in which heat is absorbed into the mass. Specific heat refers to a material's heat storing capacity. Slate fulfills both criteria well.

Provided also herein is a method of roasting nuts. The method includes: i) providing an oven comprising a lava rock cooking surface, ii) heating the lava rock cooking surface to a temperature appropriate to roast nuts, iii) Placing the nuts in position to be roasted by the lava rock cooking surface, and iv) heating the nuts for an amount of time sufficient to roast the nuts. The use of lava rocks, in particular, is advantageous because of its durability, indestructability, and function as a great heat conductor. The lava rocks may also comprise a planar surface on which the nuts may be roasted.

In another embodiment, the present invention includes a method of preparing a natural nut-roasting appliance for roasting nuts. The method includes i) mining naturally occurring lava rock, ii) Shaping mined lava rock from step i) to provide lava rock pieces having at least one flat surface suitable for placing nuts for roasting and sized to be heated and to transfer heat to said nuts sufficiently for roasting, and iii) supporting the shaped lava rocks resulting from step ii) in a closed roasting environment suitable to provide naturally-roasted nuts.

As used herein, the term, “lava rock” refers to is a rock formed from magma erupted from a volcano. It differs from other igneous rock by being of volcanic origin. By nature, lava rocks are porous, with small holes throughout the rock. This makes them an excellent heat-holding source, allowing you to distribute heat throughout your grill, into areas where the gas flames may not otherwise reach. The lava rocks absorb the heat from the gas flame and hold and distribute it to any area the lava rocks are placed, creating a more widespread cooking area as well as greater heat throughout the grill.

Lava rocks are used in grilling, and other applications of a thermal nature due to these advantageous properties. Most notably, lava rocks are used in gas grills as a way to retain heat during the cooking process. A truly efficient baking oven system should possess two thermal characteristics, thermal conductivity and specific heat, or heat storing capacity. Thermal conductivity refers to the speed and efficiency in which heat is absorbed into the mass. Specific heat refers to a material's heat storing capacity. Lava rocks fulfill both criteria well.

A lava rock oven of the present invention primarily consists of a planar lava rock surface in a closed oven environment. The planar lava rock surface may be a cooking surface on which the nuts are placed in a batch cooking process, and may include a number of lava rocks included in a planar surface. The oven may be similarly constructed as a brick oven, with a heat source in the oven itself, or below the surface of the cooking surface. The oven may be domed shaped, or have an arced roof, or it may be rectangular in shape. The oven can have one or two openings, for inserting and removing items. The opening(s) optionally have a door which can be closed to create a closed heating environment. The walls of the oven may be made of lava rocks in addition to the cooking surface.

In another embodiment, the present invention includes a method of roasting nuts. The method includes i) providing an oven comprising a charcoal heat source, ii) heating the charcoal heat source to a temperature appropriate to roast nuts, iii) placing the nuts in position to be roasted by the charcoal heat source, and iv) heating the nuts for an amount of time sufficient to roast the nuts.

In another embodiment, a method of preparing a natural nut-roasting appliance for roasting nuts is provided herein. The method includes: i) providing natural lump charcoal, ii) providing a planar cooking surface suitable for placing nuts for roasting and sized to be heated and to transfer heat to said nuts sufficiently for roasting, and iii) supporting the lump charcoal in a closed roasting environment suitable to provide naturally-roasted nuts.

Naturally made lump charcoal is heated with fire until the charcoal reaches a desired temperature. The hot charcoal is utilized with only the use of a metal pan as a roasting machine. Roasting nuts in this manner gives them a pure, organic, smoky flavor in comparison to modern methods of roasting with large machinery that often leave unnatural tastes. Dry roasting and salting nuts without the large roasting machinery also avoids the impurities, toxins, contaminates and chemical by-products that can transferred to the nuts during the roasting process and time in the factory.

Natural lump charcoal can be purchased or, preferably, made. Homemade lump charcoal is guaranteed to be natural, and can be easily completed in a 55 gallon drum packed with sourced hardwood like cherry, oak, or hickory. Then stack wood for a bonfire with a giant hole in the center for the barrel of lumbar to sit securely. After a non-flammable covering is placed on the barrel, the bonfire is lit and left until it burns out in approximately 5 hours. The coals are still hot and can be immediately used or reheated before use. Charcoal is ideal because of its ability to heat to high temperatures, it burns steadily, and it produces little smoke. Next, a fire pit is set-up to the dimensions needed based on the quantity of nuts, amount of charcoal, and any other specifications as needed. Then the charcoal is laid flat and a controlled fire is started under and around them (if they aren't already at the desired temperature), which in turn heats the charcoal to the desired roasting temperature (approximately 300° F.). Finally, simple, naturally-made tools are used to place and manipulate the nuts in the metal pan over the hot charcoal for approximately 25 minutes or until roasted.

In order to dry roast and salt nuts healthily, a natural adhesive was discovered for getting salt to stick to a surface of a nut properly. When the yerba mate herb (also known as simply mate), which is mostly utilized as a cultural and medicinal tea drink, is ground into a fine powder and mixed with small amounts of water it results in a sticky, green paste. The paste is coated directly on the nut surface before salting to better adhere the salt particles. The yerba mate herb is composed mostly of polyphenols, xanthenes, caffeoyl derivatives, saponins, and minerals which are responsible for most of the pharmacological benefits.

In an embodiment, when the terms “natural flavorant or natural adhesive” is used herein, it is contemplated that either the natural flavorant or the natural adhesive may have at least 0.5% yerba mate by weight of either or both of said natural flavorant or natural adhesive. Preferably it would contain more yerba mate; anywhere up to and including 100% of said natural flavorant or adhesive.

Polyphenols are naturally occurring molecules found in plants which provide structural support, can relieve chronic pain, have antibacterial properties, and help reverse oxidative damage to artery walls. Polyphenols are sticky in property and these molecules are what allow the herb to function as a glue substance. The yerba mate herb is touted largely for its energizing effect, due in part to the caffeine content, but it is also well known for its antioxidants; antimicrobial, cardiovascular, chemopreventative, and neuroprotective properties; as well as its use to stimulate the digestive system, promote weight loss, relieve pain and headaches, slow the aging process, and its general use as a health tonic. The various pharmological uses and the significant energizing benefits of the yerba mate herb will only increase the demand of salted roasted nuts as a naturally healthy snack.

The use of yerba mate herb is a healthier and organic method of adhering salt to roasted nuts with the added benefit of energy boosting properties and general, potential health benefits like pain relief and weight loss. Using the yerba mate herb avoids a need for extra fat in oil or butter, extra salt in a brine solution, or a processed sugar-based “gum” like xanthan gum as an adhesive.

As used herein, the term “yerba mate” or “mate” refers to the plant yerba mate, and anything derived therefrom. Yerba mate is a species of the holly family (Aquifoliaceae), with the botanical name Ilex paraguariensis. It is contemplated within the invention that other components known in the art may be combined with yerba mate to be used as an adhesive. Alternatively, yerba mate may also be used as a seasoning, or additive, and not for its adhesive functionality.

As used herein, the term “nut” refers to any kernel found within a shell, and generally used in food, and includes both tree nuts and legumes. A nut is generally known as any hard-walled edible kernel which is typically a fruit composed of a hard shell and a seed, and is generally edible. Some examples of nuts include, without limitation, almonds, peanuts, hazelnuts, chestnuts, acorns, pecans, pistachios, walnuts, Brazil nuts, candlenut, cashews, macadamia, mongono, pine nut, walnut, and Yeheb nut.

As used herein, the term, “soapstone” refers to a metamorphic rock containing talc and magnesium, and any derivative from the rock after refining, or any type of transformative process, thereof. Soapstone is relatively soft because of its high talc content, talc having a definitional value of one on the Mohs hardness scale. There is no fixed hardness for soapstone because the amount of talc it contains varies widely, from as little as 30% for architectural grades such as those used on countertops, to as much as 80% for carving grades.

Soapstone is sometimes used for the construction of fireplace surrounds, cladding on metal woodstoves, and as the preferred material for wood burning masonry heaters because it can absorb, store and evenly radiate heat due to its high density and magnesite (MgCO₃) content. Soapstone is mined and due to its high talc content it is then easily carved and molded with basic chiseling tools into a flat roasting surface before it is covered in beeswax and cured to maintain shape.

A truly efficient baking oven system should possess two thermal characteristics, thermal conductivity and specific heat, or heat storing capacity. Thermal conductivity refers to the speed and efficiency in which heat is absorbed into the mass. Specific heat refers to a material's heat storing capacity. Soapstone fulfills both criteria well.

The process of the invention can be applied to any of those edible nut varieties, including tree and ground nuts, which are conventionally packaged and sold as snack-type products. Illustrative of such nut meats are peanuts, cashews, almonds, walnuts, filberts, macadamia nuts, pecans, and the like.

The nuts may be de-shelled in a preliminary step and, optionally are also subjected to other conventional procedures such as blanching and the like, prior to being subjected to the process of the invention. When the nuts are ready to be roasted, they are subjected to roasting under conditions which may vary depending upon the particular type of raw nut and the type of roasting process, be it oil or air (i.e., dry) roasting. Illustratively, the nuts are roasted at temperatures within the range of from about 200° F. to about 450° F., for a time which will vary depending upon the particular roasting temperature employed, the particular type of nut being processed, and the degree of roasting desired. For example, the time and extent of roasting will be greater in the case of peanuts than in the case of cashews. The most appropriate roasting conditions to be adopted in any particular instance can be determined readily by a process of trial and error.

The roasting operation can be conducted on a batch or continuous basis. The residence time of the nuts in the oven is adjusted to provide the desired time of roasting; e.g., a range of about one minute to about 20 minutes. Any of the apparatuses conventionally employed in the art to effect the dry roasting of nuts can be utilized in the above batch or continuous roasting step. It is an advantage of the present invention that superior results are achieved when air roasting nuts coated in the manner described above.

An adhesive and/or a flavorant may also be used in the method of the present invention. Adhesives are well known in the art. Illustrative of suitable adhesive materials are those synthetic and derived vegetable gums such as xanthan, arabic, and guar, as well as dextrins, modified starches, and the like. Other optional ingredients to control viscosity and tackiness, including proteinaceous materials such as albuminoids, e.g., gelatin, albumins, glutenous materials, and like agents, can be present in the adhesive solution. The dry adhesive predust can employ any of these materials, preferably a dextrin or pregelatinized starch. The gelatin and like thickening/adhesive agents, are preferably employed in lesser amounts than the gums, and at levels up to about five percent by weight. In a preferred embodiment, a natural adhesive may be used, such as yerba mate. The use of this adhesive is disclosed in application number 2481-9P, filed on even date herewith, and incorporated by reference herein.

The nuts disclosed herein can also optionally be coated with any type of flavorant, or seasoning. Some examples include, non-exhaustively, allspice, anise, basil, beau monde seasoning salt, caraway, cardamom, pepper, chives, cilantro, five spice Chinese powder, garlic, ginger, juniper berries, mace, marjoram, mei yen seasoning, mint, mustard, nutmeg, oregano, paprika, parsley, pine nuts, poppyseed, pumpkin pie spice, rosemary, saffron, sage, savory, salt, sea salt, sesame seeds, shallot, soy sauce, tabasco, tarragon, thyme, turmeric, worcestireshire sauce, and zest.

In another embodiment, the seasoning and the natural adhesive are mixed together to form a seasoned adhesive prior to at least partially coating the nut. In an embodiment, the seasoning and the natural adhesive are mixed in a ratio of from about 1/20 of adhesive/salt to about ⅕ of adhesive/salt.

The nuts disclosed herein can also optionally be coated with any type of flavorant, or seasoning. Some examples include, non-exhaustively, allspice, anise, basil, beau monde seasoning salt, caraway, cardamom, pepper, chives, cilantro, five spice Chinese powder, garlic, ginger, juniper berries, mace, marjoram, mei yen seasoning, mint, mustard, nutmeg, oregano, paprika, parsley, pine nuts, poppy seed, pumpkin pie spice, rosemary, saffron, sage, savory, salt, sea salt, sesame seeds, shallot, soy sauce, tabasco, tarragon, thyme, turmeric, worcestireshire sauce, and zest.

Yerba mate contains the following beneficial vitamins, minerals, etc.:
Vitamins: A, C, E, B1, B2, Niacin (B3), B5, B Complex.
Minerals: calcium, manganese, iron, selenium, potassium, magnesium, phosphorus, and zinc.
Additional Compounds: carotene, fatty acids, chlorophyll, flavonols, polyphenols, inositol, trace minerals, antioxidants, tannins, pantothenic acid and 15 amino acids.
Theophylline, theobromine, and caffeine.

Yerba mate contains a large amount of antioxidant and pohlyphenols. Polyphenols contain antioxidant properties and have been found to aid in the prevention of several degenerative diseases, including cardiovascular disease (CVD) and cancer. Yerba mate has significant antioxidant activity. In a study published in 1995 by Biochemicaland Molecular Biology International, researchers concluded that water extracts of yerba mate “were more potent antioxidants than either ascorbic acid (vitamin C) or butylated hydroxytoluene.” A few years later, a group of researchers embarked on a study to again investigate the antioxidant properties of Ilex paraguariensis infusions. Those findings were published in March of 2000 in the journal Biochemical and Biophysica Research Communications. Their results suggest “that ingestion of extracts of Ilex paraguariensis could contribute to increase the antioxidant defense of an organism against free radicals attack.” In a more recent study, published in the November 2001 issue of Fitoterapia, researchers took a look at seven different plant species in South America. They found that yerba mate “contained a higher content of flavonoids and caffeoyl derivatives than any other assayed species.”

Yerba mate is also a good source of xanthines, caffeoyl derivatives and saponins.

Yerba mate herb may be ground down into a fine powder. It is then blended with minimal amounts of water in order to formulate a thick, sticky paste that will be coated on the nuts. Adding a small dash of salt to the paste will allow it to coat and stick more effectively. After the nuts are coated in the paste, they are tossed in salt until coated generously because every salt particle won't properly adhere so this will ensure a more even spread of salt. After the nuts are thoroughly salted, they are then roasted at 300° F. for approximately 30 minutes which allows the yerba mate coating and salt to set.

Some benefits of consuming yerba mate include taking advantage of its following properties, such as antioxidant properties. Consumption of yerba mate provides antioxidant benefits to the body. It has many different phytochemicals such as polyphenols, chlorogenic acid and caffeoyl derivatives that make it a beneficial antioxidant. Research suggests that mate extract may reduce oxidative stress that increases risk of damage to liver and heart. It also reduces nitrosative stress that may cause DNA damage, cell death and lipid peroxidation. As compared to green tea yerba mate is more effective in preventing cytotoxicity associated with blood flow restriction heart disorders such as stroke etc.

Another benefit includes cardiovascular benefits. Yerba mate contains compounds such as polyphenols that may be beneficial in reducing risk of cardiovascular diseases such as atherosclerosis. Findings of a research study suggests that intake of yerba mate has beneficial impact on lipid parameters and it helps to reduce LDL cholesterol in hypercholesterolemic people. Consumption of yerba mate protects myocardial tissue of the heart and is also beneficial in reducing oxidative stress caused by reactive oxygen species (ROS) which may cause stroke etc.

It also possesses antimicrobial properties. Research results of a study conducted to ascertain effects of yerba on E. coli suggests that it has antimicrobial properties that may help in preventing health risks caused by E. coli bacteria. Due to this it has the potential to be used as antimicrobials in various beverages and foods against E. coli. It also has significant anti-inflammatory properties. The flavanoids found in yerba mate may be beneficial in reducing inflammation. Anti-inflammatory properties make yerba mate beneficial in reducing risk of chronic disease and therefore improving overall health. It also possesses anti-cancer properties. Health benefits of yerba mate include prevention of cancer. Several studies have been conducted to evaluate the anticancer properties of yerba mate and the findings suggest that it indeed has the potential to protect human body against cancer. Yerba mate may be beneficial and reducing complications from hyperglycemia in diabetes. Hyperglycemia results in dicarbonyls which causes many diabetic complications. Yerba mate as an antioxidant plays role in the process of glycation which reduces the dicarbonyl action, resulting oxidation and hyperglycemia. Yerba mate has also been shown to have beneficial health effect in reducing obesity. This weight loss effect of yerba mate is attributed to increased fat oxidation, slowing of gastric emptying and increased feeling of satiety.

In another embodiment, the unprocessed salt is selected from group of red salt (which may be Hawaiian Alea red salt), grey marsh salt (which may be Celtic Sel Gris french marsh salt), Black sea salt (which may be Hawaiian black lava salt), Himalayan Rock salt (which may be pink Himalayan salt mined in Pakistan), and white Sea Salt. In another embodiment, the unprocessed salt is selected from the group of Himalayan salt, black lava salt, Jukyeom, Kala namak, Anglesey Sea Salt, Alaea salt, brine, Fleur de sel, Sal de Tavira, Sale Marino di Trapani, Sel gris, Sel de Guérande, and combinations thereof.

In another embodiment, a method of making a flavored foodstuff comprising a nut is provided. The method includes: i) mixing an unprocessed salt and a natural adhesive to form a seasoned adhesive mixture; ii) heating the nut to a temperature between about 300° F. and 400° F. for a time sufficient to roast the nut; and iii) coating the nut with said seasoned adhesive mixture. In an embodiment, the natural adhesive includes yerba mate. In another embodiment, the method further includes a step of preheating the nuts prior to step i).

Salt is found in variable quantities in different countries, and in various conditions from various sources like mountains, marshes, mines, lakes, below the earth surface, and the sea. Different salts hold diverse health benefits and cultural values. When saltwater is evaporated in the production of sea salt many of the natural elements of the sea like the water's minerals (contains 82 essential nutrients found in the human body), algae, or clay soil (as found in Celtic sea salt) remain, but after the salt is processed the properties of algae or clay are washed away and the extra nutrients are lost. Many health experts classify algae as a “super food” due to the high content of minerals, nutrients, and vitamins. Himalayan salt is a marine fossil salt that is harvested from the ancient sea salt deposits in the foothills of the Himalayan Mountains. It is very rich in minerals from the mountain sediment, specifically iron. The salt has been protected and kept pure for millions of years, but if processed, much of the unique health benefits would be lost. Processed and commercial salts also contain harmful additives, including aluminum silicate and different bleaches. The use of unprocessed salts from around the world introduces a healthier salted nut product with the organic benefits of nature.

A unique, healthy salted nut product created without the use of artificially added nutrients will build a new market of natural, healthy, and trendy packaged snacks. It will give the consumer a choice to select among different kinds of salt together with better understanding of the identified uniqueness of the different nutritional value, and cultural, and health benefits. Salt has been valuable to cultures from around the world for over eight thousand years, and with the new use of unprocessed, global salts the importance of salt will increase as the negative association of unhealthy salted snacks will diminish.

As used herein, the term, “mountain salt” refers to any salt naturally derived from a mountainous or other geographic region from which salt may be derived. Examples include without limitation, Himalayan salt, black lava salt, Jukyeom, and Kala namak.

As used herein, the term, “sea salt” refers to any salt naturally derived from any body of water. Examples include, without limitation Anglesey Sea Salt, Alaea salt, brine, Fleur de sel, Sal de Tavira, Sale Marino di Trapani, Sel gris, and Sel de Guérande.

As used herein, the term, “unprocessed” means a naturally occurring salt with a minimum of processing steps. Unprocessed salt undergoes a minimal amount of processing, and the unprocessed salt therefore retains most of the naturally occurring minerals, trace minerals, and nutrients as well.

As used herein the term “seasoned,” “seasoning,” or “season(s)” refers to any salt, herbs, spices, fruits, cheeses, oils, or any other ingredients used to enhance the overall organoleptic qualities of the ready-to-eat seasoned foodstuff. Some examples include, but are not limited to grapefruit juice, lemongrass juice, rind from fresh mandarin oranges, nutmeg, cinnamon, coffee, Tahitian vanilla, cloves, buckwheat honey, raspberries, ginger, basil, rosemary, cheddar, apple, and mixtures thereof.

Salt is the most often used seasoning for food. The health benefits of sea salts are found both in their high mineral content (processed salt is devoid of minerals) and their high sodium to chloride ratio. While excessive salt intake is harmful, depletion of salt from the human body is ultimately lethal. Salt is a natural adversary to many fungus, bacteria and virus and our bodies are dependent upon an intake of sodium.

Each salt has its unique taste due to its unique mix of minerals and the complex variations of salt crystals. Salt, the most commonly used of all seasonings, is defined by its contents and with sea salts this includes various ratios of minerals and various ratios of the remnants of the micro sea life that lived and died in the water. All life on earth is dependent upon the smallest creatures of the sea as the bottom of the food chain, as our primary source of oxygen, and were the most basic of chemical changes upon minerals and amino acids are caused within these microscopic creatures.

Generally, it takes less sea salt for same level of saltiness and sea salts contain dozens of trace minerals necessary for life, which table salt does not. Generally table salt is surface mined from large salt flats, for which the minerals were wash away long ago. Table salt also is the salt most exposed to contamination.

Most retail salts are the by-product of desalination plants. There are many reasons not to use the processed salts found in most retail grocery stores. First, this salt tends to be highly contaminated due to the water sources used for desalination factories. The process also strips away most mineral content and the heat process used in desalination destroys the complex micro structures of sea salt and salt water.

Processed salt is devoid of all minerals and complex molecular structures—unique to each source of the sea salt. It is these minerals and molecular structures that not only provide the health benefits of sea salt, but also the favor. The different ratios of minerals and molecular structures of each provides than a different spicing of the taste of the food.

Studies have shown enormous health benefits resulting from changing for processed table salt to sea salt—this foremost due to increasing mineral intake and reducing sodium chloride intake. However, some also believe some sea salts are naturally ionized, therefore assisting to maintaining and restoring the ionic and magnetic field within cell structures of the human body. Many people around the world will actually add some salt (not a lot) to water they drink for this reason and medical studies have shown health benefits in doing so.

Sea Salt will contain all minerals, including all trace minerals. It is the lack of trace minerals that is most lacking in people's diets today, because all commercial agricultural land is essentially devoid of minerals. Minerals removed from the soil by plants will not replace themselves. When the minerals are depleted, they are depleted basically forever unless the land is flooded occasionally with mineral rich water (which is not done).

The reason the oceans are salty is because all minerals (including salt) are continually being washed off land and into the oceans. When water evaporates from the ocean producing rain, the salt and minerals remain in the ocean. Thus, across the eons, oceans always become saltier and with higher mineral content. With each generation of crops, agricultural land loses more of its mineral content.

Most processed salt comes from such surface mines of salt flats. Water leaches and washes away the minerals and other contents. The processing of salt includes washing the salt to insure it is clean as surface salt is exposed to contamination. The washing process often washes away any remaining minerals and other ingredients of the salt. Finally, the process salt is dried under involves very high heat which may destroy the benefit of any remaining organic sourced molecular structures, and ground to small crystals. This processing removes all minerals and all other beneficial molecules from the salt.

Natural salt is the element that helps to regulate water content in the body. The balance of water and salt in the body is critical. Another key reason why natural salt is so important is because our bodies need trace elements for proper function. These elements are usually not found in food or nutritional supplements in a form that the body can utilize. However, all 82 of the essential trace elements needed by the body are found in natural unrefined sea salt and are in a bio-available form.

In general, natural sea salt helps to balance the entire body. Some of the more pronounced benefits include the following: 1) Regulates heartbeat and blood pressure. Even though refined salt can cause high blood pressure, natural salt with adequate water intake can help to stabilize irregular heartbeats and normalize blood pressure. In other words, if you have low blood pressure, taking Celtic sea salt can help to raise it. If you have high blood pressure, it can help to lower it. 2) Eliminates mucus buildup. Not only does natural sea salt help to eliminate existing mucus buildup, but it will help to prevent it. This benefit makes it very helpful for people with allergies, asthma, sinus issues, or bronchial congestion. 3) Improves brain function—sea salt is vital to the health of nerve cells and their ability to communicate and process information. Sea salt also helps to extract excess acidity and toxins from brain cells. 4) Balances blood sugars—sea salt is especially helpful for diabetics because it helps to balance blood sugars. 5) Alkalizes the body—excess acidity in the body is an underlying cause of many diseases. Salt is vital to the removal of excess acid wastes from the cells. In addition, mineral rich salt will help to maintain the optimal acid-alkaline balance. 6) Increases energy—salt and water are the key elements for the generation of hydroelectric energy in the cells. When sodium and trace minerals are deficient in the body, fatigue will set in. 7) Provides electrolyte balance—Natural sea salt will help keep the electrolyte minerals in your body balanced, releasing excess sodium and water. For problems with water retention, gradual sea salt intake can help to release excess water stored in body tissue. 8) Builds immunity—regular intake of natural sea salt and its highly absorptive minerals can give you a higher resistance to illness, infections, and disease. It can also help your body to heal faster after an injury or surgery. 9) Promotes restful sleep—the abundance of trace minerals in natural sea salt will have a calming effect on the entire nervous system. Additionally, the proper ratio of water and salt consumption can help to prevent the need to urinate during the night. 10) Prevents muscle cramps—muscle cramps are often caused by an electrolyte imbalance, especially a lack of sodium. Sea salt provides these minerals in the correct proportion. Your body will take what it needs and get rid of the rest, as long as you are drinking enough water.

Natural Celtic sea salt is light grey in color, which comes from the sea minerals and clay found in the salt flats. The clay ionizes the minerals in the salt, making it even more beneficial. Light grey Celtic salt is famous in the culinary world and is considered by many to be the best quality salt available. This salt is moist to the touch and will retain its moisture even when stored in a cool place for a long period of time. Light grey Celtic sea salt is dried only by the summer wind and sun, and it is not refined by any processing. This coarse salt is best used in cooking.

Hawaiian Red Sea Salt, also known as Alaea, is the traditional sea salt Hawaiians use for seasoning and preserving food; in healing rituals for medicinal purposes; and in ceremonies to cleanse, purify and bless tools and canoes. It is an unprocessed sea salt rich in trace minerals found in sea water. A small amount of harvested reddish Hawaiian clay (Alae) enriches the salt with iron oxide. It's available as coarse and fine crystals and works well in a salt grinder. Good for roasting or grilling meats, it's the traditional seasoning for native Hawaiian dishes such as Kalua Pig, Hawaiian Jerky, and Poke.

Fleur de Sel is believed by many chefs to be the best finishing salt on earth—lending a highly desirable level of complexity to food. It's distinguished by fine, glistening crystals in a pale shade resembling the color of summer clouds. Its crystals are irregularly sized and unevenly shaped. The smaller crystals dissolve quickly in the mouth, discharging a salty intensity. A good Fleur de Sel has about a 10.3% residual moisture which allows the crystals to repel outside moisture so they don't melt as easily as a drier salt, providing a satisfying crunch when eaten on food. Fleur de Sel is also very high in mineral content, due to the well-controlled evaporation process of the paludiers (salt rakers) who harvest it from the pans where the sea water is evaporated. It contains 0.25% calcium, 0.37% magnesium, and 0.09% potassium—as well as varying trace quantities of iron, zinc, manganese, and dozens of other minerals. All of these combine with the sodium chloride to form a well-rounded, mellow finishing salt. And finally, it is beautiful. Its moist, refractive crystals range in color from from barn owl gray to oyster white.

Black Lava Salt is from Hawaii and is a blend of unrefined sea salt and purified volcanic charcoal. This salt is evaporated in above-ground pools that formed naturally from lava flows. Activated charcoal, a proven anti-toxin and digestive-tract palliative, is added for color and for its detoxifying effects. Many people take it as a nutritional supplement.

Black Lava Salt has an unforgettable aroma and important health benefits from the charcoal in the lava. Its striking color and interesting smoky taste make it a great finishing salt for any dish. It's especially good on salads, vegetables, sushi, grilled steak, teriyaki chicken or tofu. Charcoal is good as a natural aid for stomach and gas ailments. It also helps prevent the stomach and intestines from absorbing most poisons or drugs.

Laboratory testing has shown that Premier Pink Salt contains quantum state phytonutrients that deliver the Quantum Nutrient Effect. The Quantum Nutrient Effect (QNE) refers to the phenomenon of truly synergistic nutrients working together to create an effect far greater than the sum of their individual benefits—by a factor of 2 to 100 fold or more. This combination promotes the most rapid shift to ideal cellular resonance for targeted organs and glands in the body, thus helping achieve a quantum leap to greater health.

Many alternative health practitioners advocate the use of sea salt as a healthful seasoning. They believe that Celtic sea salt, Himalayan sea salt and Hawaiian sea salt all contain natural trace minerals that help balance electrolytes. The more sodium you eat, the more magnesium and potassium you need to keep your body in balance. Sea salt naturally contains magnesium and potassium, but these minerals are removed from standard table salt. By using sea salt instead of table salt, you can maintain your electrolyte levels more easily.

Red salt from Kauai is infused with alaea, a type of Hawaiian clay. The clay tints the salt red because it contains iron oxide, which serves as an added nutrient. Black salt from Kauai contains activated charcoal, which is used as a detoxification agent and an antidote to poisons. Although Hawaiian salt does not contain a large enough quantity of activated charcoal for it to have strong detoxification properties, this mineral may contribute to the salt's reputation as a health supplement.

A soapstone oven of the present invention primarily consists of a planar soapstone surface in a closed oven environment. The planar soapstone surface may be a cooking surface on which the nuts are placed in a batch cooking process, the planar surface may be one slab of soapstone, or it may be more than one soapstone slab forming a planar surface. The oven may be similarly constructed as a brick oven, with a heat source in the oven itself, or below the surface of the cooking surface. The oven may be domed shaped, or have an arced roof, or it may be rectangular in shape. The oven can have one or two openings, for inserting and removing items. The opening(s) optionally have a door which can be closed to create a closed heating environment. The walls of the oven may be made of soapstone in addition to the cooking surface.

In a preferred embodiment, a natural, unprocessed salt may be used in with the nuts made in the process of the present invention. Such nuts with unprocessed salts are disclosed in concurrently filed application number 2481-8P, which is herein incorporated by reference in its entirety.

### EXAMPLES

The present invention is further exemplified, but not limited, by the following representative examples, which are intended to illustrate the invention and are not to be construed as being limitations thereto.

### Example 1

The following ingredients are used in making a flavored foodstuff according to the presently claimed invention.

Ingredients

1 cup of water (8 oz)

½ tea spoon of yerba mate (0.0154 oz)

1 tea spoon of salt, comprised of one (or combination) of the following:

Red salt (0.0950 z)

Black salt (0.1146 oz)

White salt (0.1670 oz)

Grey salt (0.1425 oz)

Pink salt (0.1935 oz)

Procedure

The salt, in this case extra fine grain Himalayan salt (alternatively, can use Sel Gris Celtic salt, Alaea red Hawaiian salt, organic sea salt, Hiwa Kai black lava salt), is put in a large mixing bowl with 1 cup of water (8 oz) and ¼ tea spoon of yerba mate (0.0154 oz), and mixed for 30 minutes.

The nuts, in this case the almonds, are spread flat on a natural surface slab, in this case soapstone (slate rock and lava rock may also be used). The soapstone slap is placed within a hot gas burning oven. The oven is pre-heated for about 10 minutes to about 350° F.

The almonds are roasted at 350° F. (or generally between 270° F. and 390° F.) for 8 minutes, or until a nutty aroma wafts out of the oven. The almonds should be a golden brown color. The almonds are then removed from oven on the slab and placed on a heat-resistant surface.

The hot almonds are immediately coated with the fine grain Himalayan salt and the powder yerba mate mixture. The almonds have to be cooled entirely prior to being served or packaged. The temperatures and times given above are those that are preferred. Obviously they may be varied based on the oven and amount of nuts roasting, roasting slab choice, and type of nut being roasted.

The above and other beneficial objects and advantages are accomplished in accordance with the present invention by a preconditioning process for the nuts, which comprises:
(a) storing the nuts in a conditioned environment having a temperature in the range of about 45 degrees F. to 55 degrees F. for sufficient time that the temperature of substantially each nut is uniform between its center and surface, and
(b) uniformly heating the conditioned nuts with heated air so as to cause the surface cells of the nuts to expand.

Raw nuts and seeds, generally having been stored at low preserving temperatures, are placed in open bins in layers having a depth between about 24 and 48 inches. Air having a temperature in the range of 78 degrees F. to 95 degrees F. is circulated around and through the bins for about 24 hours. Such treatment produced a conditioned nut product wherein the temperature of substantially each nut is uniform between its center and surface. In the absence of the conditioning treatment, the nuts will undergo internal scorching during the subsequent heat treatment.

The conditioned nuts are subsequently subjected to treatment with heated air which causes the surface cells of nuts to expand. Although the air temperature and time of exposure will vary with each nut or seed product because of its size and cellular structure, air temperatures will generally be in the range of 300 degrees F. to 400 degrees F., and exposure times will generally be in the range of 3 to 8 minutes. The heated nuts, having a slightly expanded surface, are highly permeable to a sodium chloride solution, especially when the nuts are still at an elevated temperature at the instant of application of the solution.

Nuts and seeds susceptible to improvement by the process of this invention are free of an intact inedible outer shell. Typical species include nuts such as almond, pecan, walnut, peanut, pistachio, macadamia, hazel, brazil, cashew, and sees such as pumpkin, and sunflower.

Thus while there have been described what are presently believed to be preferred embodiments of the invention, those skilled in the art will realize that changes and modifications may be made thereto without departing from the spirit of the invention, and it is intended to claim all such changes and modifications as fall within the true scope of the invention.

What is claimed is:

1. A method of roasting nuts comprising:
i) Providing a natural stone oven;
ii) Heating said natural stone oven to a temperature appropriate to roast nuts;
iii) Placing said nuts in said natural stone oven to be roasted; and
iv) Heating said nuts for an amount of time sufficient to roast said nuts.

2. The method of roasting nuts according to claim 1 wherein said natural stone oven is selected from the group comprising lava rock, soapstone, slate, and charcoal.

3. The method of roasting nuts according to claim 1 wherein said natural stone oven is comprised of soapstone.

4. The method of roasting nuts according to claim 1 wherein said natural stone oven is comprised of slate.

5. The method of roasting nuts according to claim 1 wherein said natural stone oven is comprised of lava rock.

6. A method of roasting nuts according to claim 1 further comprising at least partially coating said nut with a natural flavorant or natural adhesive.

7. The method according to claim 1 wherein said natural stone oven is heated by a heat source selected from the group of gas, coal, charcoal, electric, infrared, or wood-burning.

8. The method according to claim 1 wherein said natural stone oven has a substantially planar cooking surface.

9. The method according to claim 8 wherein said nuts are heated directly on said planar surface.

10. The method according to claim 1 wherein said temperature appropriate to roast said nuts is between about 200° F. and about 450° F.

11. The method according to claim 1 wherein said time sufficient to roast said nuts is between about 1 minutes and about 30 minutes.

12. The method according to claim 1 wherein the nuts are almonds.

13. The method of claim 6 further comprising coating said nuts with a natural adhesive selected from the group of xanthan, arabic, guar, dextrins, modified starches, a dried adhesive, or yerba mate.

14. The method of claim 6 comprising adding a natural flavorant to said nuts after said natural adhesive has been added, said natural flavorant selected from the group of salts, sea salts, and unprocessed salt.

15. A natural stone oven designed for roasting nuts, said oven comprising: a natural stone heating surface designed for retaining and transmitting heat from a source to nuts placed in a roasting position.

16. The natural stone oven according to claim 15 wherein said natural stone heating surface is selected from the group consisting of soapstone, slate, and lava rock.

17. The natural stone oven according to claim 15 comprising a planar surface in a closed heating environment.
